(19) United States
(12) Patent Application Publication
(10) Pub. No.: US 2024/0209686 A1
(43) Pub. Date: Jun. 27, 2024

(54) SPRING DRIVING SYSTEM FOR CORDLESS SOFT GAUZE CURTAIN

(71) Applicant: Guangzhou Jue Decoration Window Decoration Technology Co., Ltd, Guangzhou (CN)

(72) Inventor: Yongzhong QIU, Guangzhou (CN)

(73) Assignee: Guangzhou Jue Decoration Window Decoration Technology Co., Ltd, Guangzhou (CN)

(21) Appl. No.: 18/596,242

(22) Filed: Mar. 5, 2024

Related U.S. Application Data
(63) Continuation of application No. PCT/CN2023/093457, filed on May 11, 2023.

(30) Foreign Application Priority Data
May 13, 2022 (CN) 2022211534943

(51) Int. Cl. E06B 9/60; E06B 9/24; E06B 9/42

(52) U.S. Cl. CPC E06B 9/60; E06B 9/42; E06B 2009/2405; E06B 2009/2458

(57) ABSTRACT

The present disclosure relates to the technical field of mechanical transmission, in particular to a spring driving system for a cordless soft gauze curtain, including a first spring joint, a transmission intermediate pipe, a main spring, and a retarder, wherein the transmission intermediate pipe is sleeved with the main spring, one end of the transmission intermediate pipe is sleeved with the first spring joint, the first spring joint is connected to the transmission intermediate pipe through a pin, the other end of the transmission intermediate pipe is sleeved with the retarder, and the main spring is connected to the first spring joint and the retarder, respectively. The spring driving system for the cordless soft gauze curtain has the advantages of reducing the safety risk and the length of the spring and being low in fault rate.

### CROSS-REFERENCE TO RELATED APPLICATIONS

The application claims priority to Chinese patent application No. 2022211534943, filed on May 13, 2022, the entire contents of which are incorporated herein by reference.

### TECHNICAL FIELD

The present disclosure relates to the technical field of mechanical transmission, in particular to a spring driving system for a cordless soft gauze curtain.

### BACKGROUND

A soft gauze curtain generally refers to a zebra blind, and it is a dimmable double-layer roller blind. A fabric of the soft gauze curtain consists of a strip-shaped semi-transparent part and a shading part, and the two parts have the same width and are staggered from each other. When the two layers of the soft gauze curtain completely overlap, a semi-shading effect can be achieved. When the two layers of the soft gauze curtain are completely staggered, a full-shading effect can be achieved. Therefore, an overlap ratio of the two layers of the soft gauze curtain can be controlled by only fixing one end of the soft gauze curtain and mounting the other end thereof on a reel pipe for reeling, and thus, a dimming function is achieved. In order to control the rotation of the reel pipe, it is necessary to mount a suitable driving system for the reel pipe.

An existing soft gauze curtain generally adopts a pull-bead-type corded driving system, which drives the reel pipe to rotate by engagement between each of pull beads and a mechanical part. However, the pull beads are easy to loose and fall off, which causes a safety risk that the pull beads are eaten by children by accident. Therefore, the pull beads are prohibited in some countries, and a novel spring driving system will be used instead.

In addition, the soft gauze curtain is based on a principle that shading adjustment is performed by means of its own misalignment, and therefore, the length of the fabric is twice that of an ordinary rolling blind, which facilitates forming a double-layer structure. In order to pre-tighten a longer soft gauze curtain, the existing spring driving system needs to adopt a lengthened spring to increase the number of coils so as to ensure a pre-tightening force, and the soft gauze curtain is also provided with a lower beam counterweight to increase the flatness, which puts forward higher requirements for the pre-tightening force of the spring and further increases the expected length of the spring. Overlong springs are not only difficult to mount and debug, but also easy to damage and high in fault rate. Therefore, the novel spring driving system is needed to solve the above-mentioned defects.

### SUMMARY

In order to overcome technical defects of safety risk, overlong spring and high fault rate existing in an existing spring driving system, the present disclosure provides a spring driving system for a cordless soft gauze curtain, which reduces the safety risk and the length of a spring and is low in fault rate.

In order to solve the above-mentioned problems, the present disclosure is achieved according to the following technical solutions:

a spring driving system for a cordless soft gauze curtain in the present disclosure includes a first spring joint, a transmission intermediate pipe, a main spring, and a retarder, wherein the transmission intermediate pipe is sleeved with the main spring, one end of the transmission intermediate pipe is sleeved with the first spring joint, the first spring joint is connected to the transmission intermediate pipe through a pin, the other end of the transmission intermediate pipe is sleeved with the retarder, and the main spring is connected to the first spring joint and the retarder, respectively.

The transmission intermediate pipe is symmetrically provided with limiting slots.

First limiting flanges are symmetrically disposed in a port of the first spring joint.

The retarder consists of a second spring joint, a first retarding module, a second retarding module, and a driving wheel, the second spring joint is sleeved with the driving wheel, the first retarding module and the second retarding module are disposed between the driving wheel and the second spring joint, and the second spring joint, the first retarding module, the second retarding module and the driving wheel are sequentially connected in a clamping way.

The second spring joint is symmetrically provided with spring bayonets, an oil slot hole is formed in the second spring joint, an end surface of the second spring joint is provided with first connecting flanges in four-corner symmetry, and the second spring joint among the first connecting flanges is provided with a gear mounting hole.

The first retarding module consists of a fixed cover, a first sun gear, first planetary gears, and a first planetary gear cover, the fixed cover is provided with the first planetary gear cover, at least one of the first planetary gears is disposed between the first planetary gear cover and the fixed cover, at least one of the first planetary gears is disposed in central symmetry, and the first sun gear is disposed in the first planetary gear cover among the first planetary gears.

Stepped slots are spaced in the fixed cover, and connecting holes are uniformly distributed in an end surface of the fixed cover.

Second limiting flanges are symmetrically disposed on an inner side of the first sun gear.

The second retarding module consists of a gear sleeve, a second sun gear, second planetary gears, and a second planetary gear cover, the gear sleeve is provided with the second planetary gear cover, at least one of the second planetary gears is disposed between the second planetary gear cover and the gear sleeve, at least one of the second planetary gears is disposed in central symmetry, and the second sun gear is disposed in the second planetary gear cover among the second planetary gears.

The gear sleeve is provided with second connecting flanges in four-corner symmetry.

An oil slot center hole is formed in the driving wheel, transmission teeth are uniformly distributed on an inner side of the driving wheel, at least one rib is spaced on the driving wheel, and buckles and connecting studs are spaced on a port of the driving wheel.

Compared with the prior art, the present disclosure has the beneficial effects that:
the spring driving system for the cordless soft gauze curtain in the present disclosure has the advantages of reducing the safety risk and the length of the spring and being low in fault rate. By replacing a commonly used pull bead structure with a transmission structure including the first spring joint, the transmission intermediate pipe, the main spring, and the retarder, children are prevented from eating dropped beads by mistake, so that the safety risk of the existing driving system for the soft gauze curtain is greatly reduced; speed reducing and torque increasing functions of the retarder are realized by the second spring joint, the first retarding module, the second retarding module, and the driving wheel, and therefore, the purpose of pre-tighting can be achieved with a larger and shorter spring instead of a lengthened spring; in addition, the present application is compact in structure, reliable in component transmission logic, and not easy to damage due to the adoption of the larger and shorter spring instead of the long spring, so that the fault rate is reduced, the problems of safety risk, overlong spring and high fault rate existing in the existing spring driving system are solved, and use demands on the soft gauze curtain are satisfied.

### BRIEF DESCRIPTION OF DRAWINGS

Specific implementations of the present disclosure will be further described in detail below in conjunction with the accompanying drawings, in which:

FIG. 1 is a schematic structural diagram of the present disclosure;

FIG. 2 is a schematic diagram of a three-dimensional structure of a first spring joint in the present disclosure;

FIG. 3 is a schematic diagram of a three-dimensional structure of a transmission intermediate pipe in the present disclosure;

FIG. 4 is a schematic structural diagram of a retarder in the present disclosure;

FIG. 5 is a first schematic diagram of a three-dimensional structure of a second spring joint in the present disclosure;

FIG. 6 is a second schematic diagram of a three-dimensional structure of the second spring joint in the present disclosure;

FIG. 7 is a schematic diagram of an exploded structure of a first retarding module in the present disclosure;

FIG. 8 is a schematic diagram of a three-dimensional structure of a fixed cover in the present disclosure;

FIG. 9 is a schematic diagram of a three-dimensional structure of a first sun gear in the present disclosure;

FIG. 10 is a schematic diagram of an exploded structure of a second retarding module in the present disclosure;

FIG. 11 is a first schematic diagram of a three-dimensional structure of a driving wheel in the present disclosure; and

FIG. 12 is a second schematic diagram of a three-dimensional structure of the driving wheel in the present disclosure.

### In which:

1, first spring joint; 101, first limiting flange; 102, pin;
2, transmission intermediate pipe; 201, limiting slot;
3, main spring;
4, retarder; 401, second spring joint; 4011, spring bayonet; 4012, oil slot hole; 4013, first connecting flange; 4014, gear mounting hole;
402, first retarding module; 4021, fixed cover; 4022, first sun gear; 4023, first planetary gear; 4024, first planetary gear cover; 4025, stepped slot; 4026, connecting hole; 4027, se1cond limiting flange;

403, second retarding module; 4031, gear sleeve; 4032, second sun gear; 4033, second planetary gear; 4034, second planetary gear cover; 4035, second connecting flange;
404, driving wheel; 4041, oil slot center hole; 4042, transmission teeth; 4043, rib; 4044, buckle; 4045, connecting stud.

### DETAILED DESCRIPTION OF THE EMBODIMENTS

Preferred embodiments of the present disclosure will be described below in conjunction with the accompanying drawings. It should be understood that the preferred embodiments described herein are merely intended to describe and explain the present disclosure, rather than to limit the present disclosure.

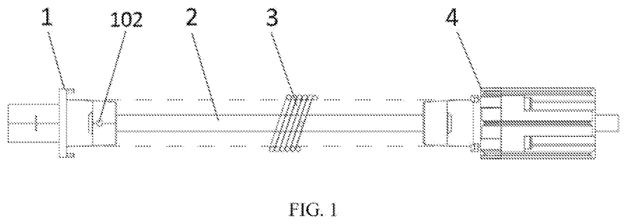

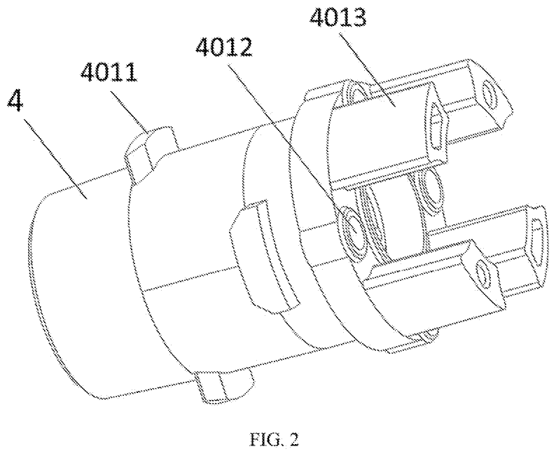

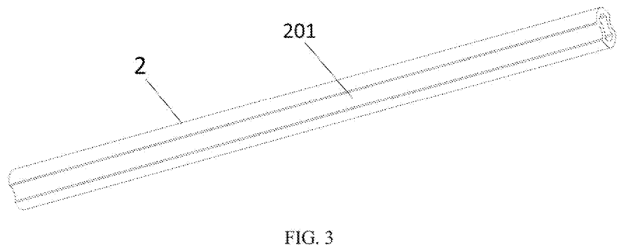

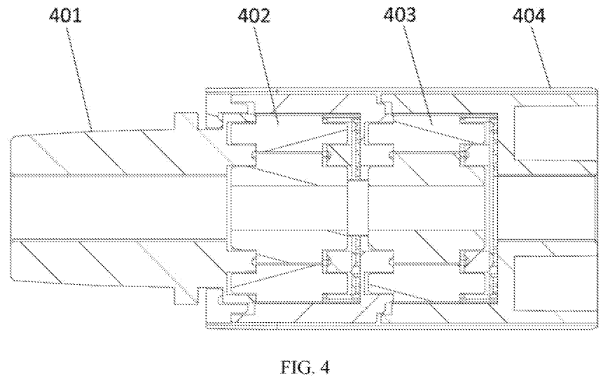

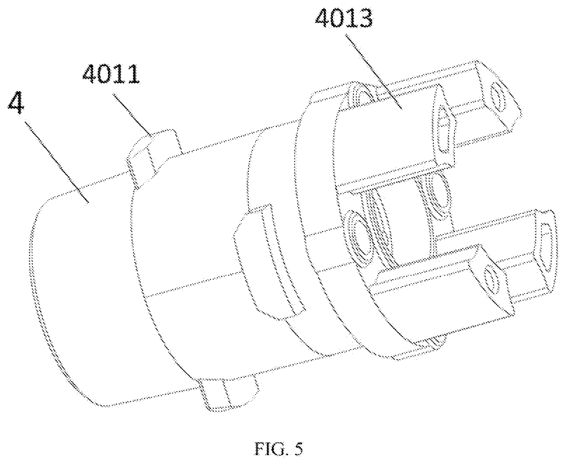

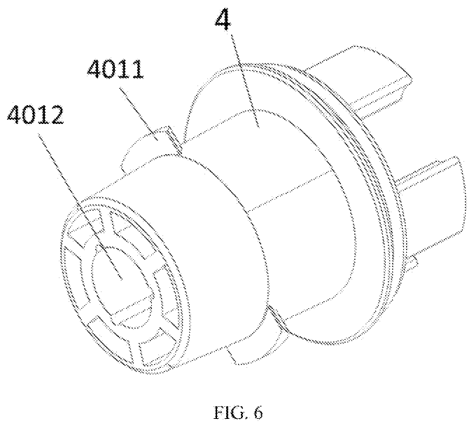

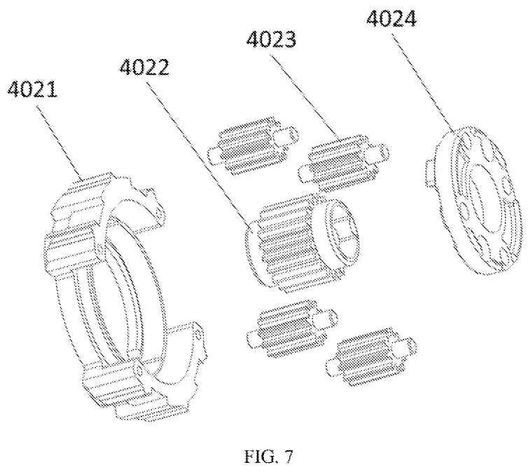

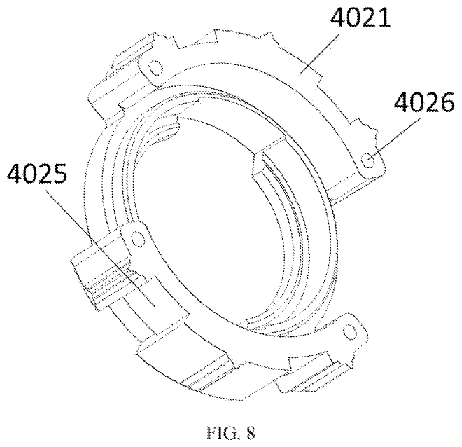

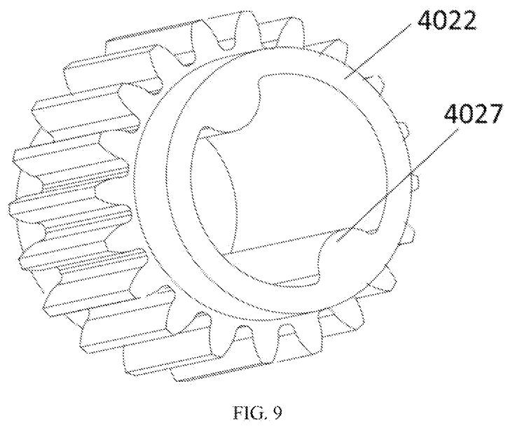

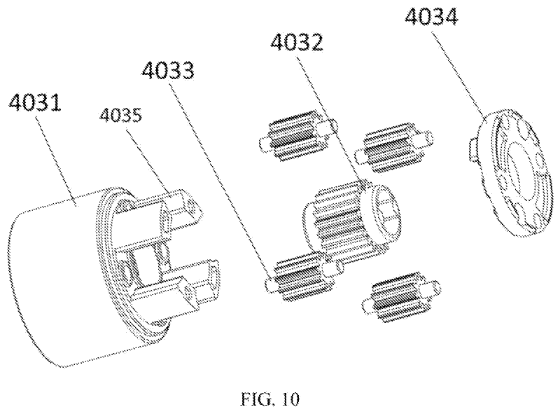

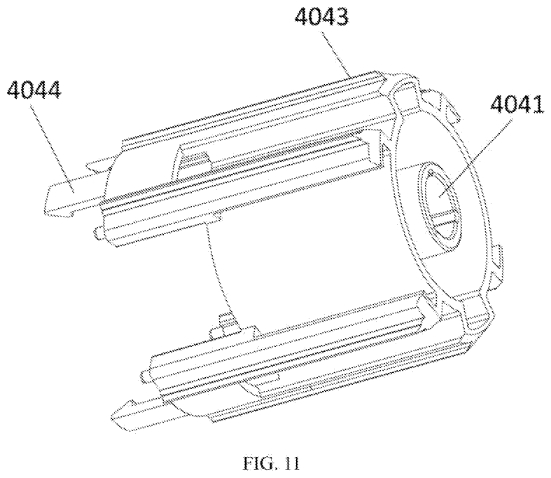

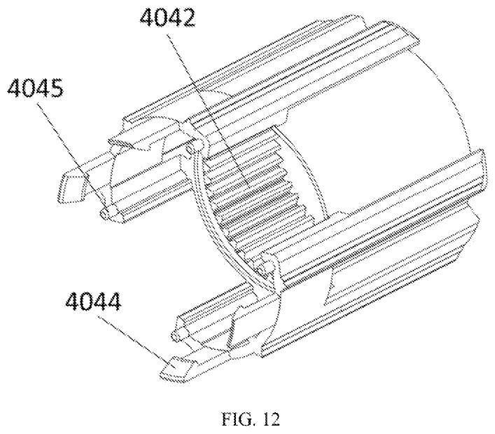

As shown in FIG. 1 to FIG. 12, a spring driving system for a cordless soft gauze curtain in the present disclosure includes a first spring joint 1, a transmission intermediate pipe 2, a main spring 3, and a retarder 4, wherein the transmission intermediate pipe 2 is cylindrical, is symmetrically provided with limiting slots 201, and is sleeved with the main spring 3, one end of the transmission intermediate pipe 2 is sleeved with the first spring joint 1, first limiting flanges 101 are symmetrically disposed in a port of the first spring joint 1, the first limiting flanges 101 are used to cooperate with the limiting slots 201 to limit the transmission intermediate pipe 2 so that the transmission intermediate pipe 2 cannot rotate, and the first spring joint 1 is connected to the transmission intermediate pipe 2 through a pin 102 so that the transmission intermediate pipe 2 cannot be separated from the first spring joint 1.

The other end of the transmission intermediate pipe 2 is sleeved with the retarder 4, and the main spring 3 is connected to the first spring joint 1 and the retarder 4, respectively. The retarder 4 consists of a second spring joint 401, a first retarding module 402, a second retarding module 403, and a driving wheel 404, the second spring joint 401 is symmetrically provided with spring bayonets 4011, the first spring joint 1 is provided with the same spring bayonets 4011 so as to facilitate mounting and connecting the main spring 3, an oil slot hole 4012 is formed in the second spring joint 401 and is used for discharging lubricating oil, an end surface of the second spring joint 401 is provided with first connecting flanges 4013 in four-corner symmetry, and the second spring joint 401 among the first connecting flanges 4013 is provided with a gear mounting hole 4014.

The second spring joint 401 is sleeved with the driving wheel 404, the driving wheel 404 is used to be connected to a load for transmission, and then, the load is transferred to the main spring 3 by the retarder 4, so that a function of pre-tighting is realized; an oil slot center hole 4041 is formed in the driving wheel 404 and is used for discharging lubricating oil, transmission teeth 4042 are uniformly distributed on an inner side of the driving wheel 404, at least one rib 4043 generally cooperating with a reel pipe system of the soft gauze curtain in the present application is spaced on the driving wheel 404, the rib 4043 is used to be mounted in a reel pipe and is in interference fit so as to enhance the stability; and buckles 4044 and connecting studs 4045 are spaced on a port of the driving wheel 404, the first retarding module 402 and the second retarding module 403 are disposed between the driving wheel404 and the second spring joint 401, and the second spring joint 401, the first retarding module 402, the second retarding module 403 and the driving wheel 404 are sequentially connected in a clamping way.

The first retarding module 402 consists of a fixed cover 4021, a first sun gear 4022, first planetary gears 4023, and a first planetary gear cover 4024, stepped slots 4025 used to cooperate with the buckles 4044 of the driving wheel 404 for connection in a clamping way are spaced in the fixed cover 4021, connecting holes 4026 used to cooperate with the connecting studs 4045 of the driving wheel 404 for mounting are uniformly distributed in an end surface of the fixed cover 4021, the fixed cover 4021 is provided with the first planetary gear cover 4024, at least one of the first planetary gears 4023 is disposed between the first planetary gear cover 4024 and the fixed cover 4021, at least one of the first planetary gears 4023 is disposed in central symmetry, the first planetary gears 4023 is disposed in the gear mounting hole 4014, the first sun gear 4022 is disposed in the first planetary gear cover 4024 among the first planetary gears 4023, second limiting flanges 4027 are symmetrically disposed on an inner side of the first sun gear 4022, and the second limiting flanges 4027 are used to cooperate with the limiting slots 201 for limiting so that relative rotation between the first sun gear 4022 and the transmission intermediate pipe 2 cannot be realized.

The second retarding module 403 consists of a gear sleeve 4031, a second sun gear 4032, second planetary gears 4033, and a second planetary gear cover 4034, the gear sleeve 4031 is provided with second connecting flanges 4035 in four-corner symmetry, the gear sleeve 4031 is provided with the second planetary gear cover 4034, at least one of the second planetary gears 4033 is disposed between the second planetary gear cover 4034 and the gear sleeve 4031, at least one of the second planetary gears 4033 is disposed in central symmetry, and the second sun gear 4032 is disposed in the second planetary gear cover 4034 among the second planetary gears 4033.

The spring driving system for the cordless soft gauze curtain has the advantages of reducing the safety risk and the length of the spring and being low in fault rate. By replacing a commonly used pull bead structure with a transmission structure including the first spring joint 1, the transmission intermediate pipe 2, the main spring 3, and the retarder 4, children are prevented from eating dropped beads by mistake, so that the safety risk of the existing driving system for the soft gauze curtain is greatly reduced; speed reducing and torque increasing functions of the retarder 4 are realized by the second spring joint 401, the first retarding module 402, the second retarding module 403, and the driving wheel 404, and therefore, the purpose of pre-tighting can be achieved with a larger and shorter spring instead of a lengthened spring; in addition, the present application is compact in structure, reliable in component transmission logic, and not easy to damage due to the adoption of the larger and shorter spring instead of the long spring, so that the fault rate is reduced, the problems of safety risk, overlong spring and high fault rate existing in the existing spring driving system are solved, and use demands on the soft gauze curtain are satisfied.

The above descriptions are merely preferred embodiments of the present disclosure, rather than limitations on the present disclosure in any forms. Therefore, any alterations, equivalent changes and modifications made, without departing from contents of technical solutions of the present disclosure, for the above-mentioned embodiments according to the technical essence of the present disclosure still fall into the scope of the technical solutions of the present disclosure.

What is claimed is:

1. A spring driving system for a cordless soft gauze curtain, comprising a first spring joint (1), a transmission intermediate pipe (2), a main spring (3), and a retarder (4), wherein the transmission intermediate pipe (2) is sleeved with the main spring (3), one end of the transmission intermediate pipe (2) is sleeved with the first spring joint (1), the first spring joint (1) is connected to the transmission intermediate pipe (2) through a pin (102), the other end of the transmission intermediate pipe (2) is sleeved with the retarder (4), and the main spring (3) is connected to the first spring joint (1) and the retarder (4), respectively.

2. The spring driving system for a cordless soft gauze curtain according to claim 1, wherein the transmission intermediate pipe (2) is symmetrically provided with limiting slots (201).

3. The spring driving system for a cordless soft gauze curtain according to claim 1, wherein first limiting flanges (101) are symmetrically disposed in a port of the first spring joint (1).

4. The spring driving system for a cordless soft gauze curtain according to claim 1, wherein the retarder (4) consists of a second spring joint (401), a first retarding module (402), a second retarding module (403), and a driving wheel (404), the second spring joint (401) is sleeved with the driving wheel (404), the first retarding module (402) and the second retarding module (403) are disposed between the driving wheel(404) and the second spring joint (401), and the second spring joint (401), the first retarding module (402), the second retarding module (403) and the driving wheel (404) are sequentially connected in a clamping way.

5. The spring driving system for a cordless soft gauze curtain according to claim 4, wherein the second spring joint (401) is symmetrically provided with spring bayonets (4011), an oil slot hole (4012) is formed in the second spring joint (401), an end surface of the second spring joint (401) is provided with first connecting flanges (4013) in four-corner symmetry, and the second spring joint (401) among the first connecting flanges (4013) is provided with a gear mounting hole (4014).

6. The spring driving system for a cordless soft gauze curtain according to claim 4, wherein the first retarding module (402) consists of a fixed cover (4021), a first sun gear (4022), first planetary gears (4023), and a first planetary gear cover (4024), the fixed cover (4021) is provided with the first planetary gear cover (4024), at least one of the first planetary gears (4023) is disposed between the first planetary gear cover (4024) and the fixed cover (4021), at least one of the first planetary gears (4023) is disposed in central symmetry, and the first sun gear (4022) is disposed in the first planetary gear cover (4024) among the first planetary gears (4023).

7. The spring driving system for a cordless soft gauze curtain according to claim 6, wherein stepped slots (4025) are spaced in the fixed cover (4021), and connecting holes (4026) are uniformly distributed in an end surface of the fixed cover (4021).

8. The spring driving system for a cordless soft gauze curtain according to claim 4, wherein the second retarding module (403) consists of a gear sleeve (4031), a second sun gear (4032), second planetary gears (4033), and a second planetary gear cover (4034), the gear sleeve (4031) is provided with the second planetary gear cover (4034), at least one of the second planetary gears (4033) is disposed between the second planetary gear cover (4034) and the gear sleeve (4031), at least one of the second planetary gears (4033) is disposed in central symmetry, and the second sun gear (4032) is disposed in the second planetary gear cover (4034) among the second planetary gears (4033).

9. The spring driving system for a cordless soft gauze curtain according to claim 8, wherein the gear sleeve (4031) is provided with second connecting flanges (4035) in four-corner symmetry.

10. The spring driving system for a cordless soft gauze curtain according to claim 1, wherein an oil slot center hole (4041) is formed in the driving wheel (404), transmission teeth (4042) are uniformly distributed on an inner side of the driving wheel (404), at least one rib (4043) is spaced on the driving wheel (404), and buckles (4044) and connecting studs (4045) are spaced on a port of the driving wheel (404).
